(19) United States
(12) Patent Application Publication
(10) Pub. No.: US 2003/0151690 A1
(43) Pub. Date: Aug. 14, 2003

(54) Camera that uses flash illumination to assist in a composition

(76) Inventors: Kirk Tecu, Greeley, CO (US); William Robert Haas, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/077,500

(22) Filed: Feb. 14, 2002

(51) Int. Cl. H04N 5/222

(52) U.S. Cl. 348/370

(57) ABSTRACT

A camera uses its strobe or flash unit to provide scene lighting while a photographer is composing a photograph.

### FIELD OF THE INVENTION

The present invention relates generally to photography and more specifically to a photography using a flash or strobe light.

### BACKGROUND OF THE INVENTION

Low light conditions present a variety of difficulties to photographers. One of these is difficulty in properly composing a photograph. Composing a photograph is also sometimes called framing. Composing a photograph is the selection of a camera position, viewing direction, and angular field of view such that the desired parts of the scene are included in the photograph, other parts of the scene are excluded from the photograph, and objects in the scene are in a desired relationship to each other in the photograph.

Composition is often accomplished with the aid of a viewfinder. A viewfinder is an optical system that the photographer looks through to see a representation of the composition of the image. Some viewfinders use the camera's taking lens for viewing, and some viewfinders have a separate optical system that approximates the view of the taking lens. If the camera is a digital camera, it may have a preview screen in addition to or instead of a viewfinder. A preview screen is typically an LCD display that displays successive preview photographs taken by the camera in a preview mode. Either of these devices may fail in low light conditions. The viewfinder may not gather enough light for the photographer to distinguish objects in the scene sufficiently to compose a photograph. A digital camera may not be able to take usable preview photographs with a sufficient frequency to allow the photographer to compose a final photograph.

The final photograph may be taken with an extended exposure time, but using a long exposure time for the preview photographs may make the composition process unacceptably slow, especially if the scene is changing. A few cameras have built-in light sources to aid in automatic focusing, but these are often of low power, and the additional component adds cost to the camera.

Some cameras have a built-in strobe for supplying light to the scene when a final photograph is taken. Some of these cameras flash the strobe after composition is complete for reducing the “red-eye” effect or for estimating the proper strobe energy for good exposure of the final photograph. However, because these uses of the strobe occur after composition is complete, they come too late to aid the photographer in composition.

There is a need for a camera that can assist the photographer with composing a photograph in low light conditions.

### SUMMARY OF THE INVENTION

A camera uses its strobe or flash unit to provide scene lighting while a photographer is composing a photograph.

### BRIEF DESCRIPTION OF THE DRAWINGS

FIG. 1 is a simplified block diagram of a camera.

FIG. 2 is a flowchart depicting steps that may be taken in implementing an example embodiment of the invention by a digital camera with a display screen.

FIG. 3 is a flowchart depicting steps that may be taken in implementing an example embodiment of the invention by a film camera or a digital camera without a display screen.

### DETAILED DESCRIPTION OF THE PREFERRED EMBODIMENT

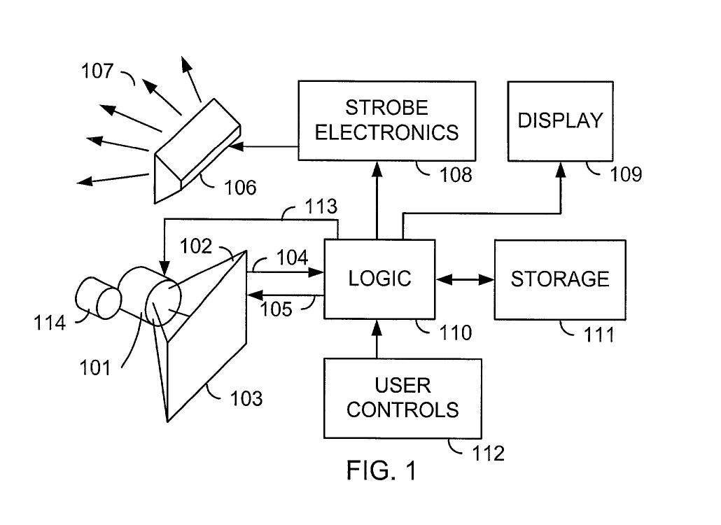

FIG. 1 shows a block diagram of a digital camera. The lens (101) gathers light from a scene (not shown). The gathered light is redirected (102) to form an image of the scene on a sensor (103). The sensor may be an array of CCD elements, CMOS sensors, or the like. The operation of the lens may be controlled by control signals (113) from a logic unit (110) which contains a microprocessor system. Likewise the operation of the sensor may be controlled by control signals (105) from logic unit (110). Image information signals (104) flow from the sensor to the logic unit (110). A flash, or strobe (106) may be utilized to supply additional light (107) to the scene. The strobe is operated by the strobe electronics (108), which in turn are controlled by the logic unit (110). The camera may comprise a display (109) on which image data may be shown. The camera may comprise a storage unit (111) for storage and recall of image data, as well as data interchange with other devices (not shown). The user of the camera may operate various control inputs (112) in order to affect the operation of the camera. A viewfinder (114) may provide a representation of the composition of a photograph. The viewfinder (114) may be associated with the lens (101) for viewing through the lens (101) or the viewfinder (114) and the lens (101) may be coupled such that any change in the angular field of view of the lens (101), typically caused by changes in focal length during zooming of the lens, are duplicated in the viewfinder (114).

While FIG. 1 depicts a digital camera, it will be understood that the present invention may be embodied in a film camera as well.

When composing a photograph, a photographer may look through viewfinder (114), or may watch a series of preview photographs on the display (109). Using the viewfinder (114) or display (109) view, the photographer may select a viewpoint, viewing direction, and angular field of view that will result in the desired composition.

In a modern camera, the strobe electronics (108) may contain circuitry for adjusting the energy delivered to the strobe (106) on each flash of the strobe (106). Electrical energy may be stored in the strobe electronics (108), which may have a maximum energy storage capacity. All or part of the stored energy may be dissipated during any single flash of the strobe. Typically, this adjustability is used to assist in achieving proper exposure in photographs taken with the strobe (106).

In an example embodiment of the present invention, the camera flashes the strobe (106) one or more times during the time the photographer is composing a photograph, thus providing additional light (107) to the scene. This additional light (107) enables the photographer to see objects in the viewfinder (114) more clearly, or in the case of a digital camera with a preview display (109), enables the camera to take preview photographs of usable quality often enough to allow the photographer to compose the scene.

The preview mode or composition time may be initiated by the photographer using a control input (112) of the camera. For example, the camera may enter the preview mode when the shutter release button in partially depressed. The control that initiates the taking of a photograph is often called a shutter release, even though the camera, such as a digital camera, may not have a physical shutter. Additionally, the camera may have a control such as a button, knob, dial, switch, menu selection, or other device that enables or disables the strobe flashes during the composition of a photograph.

Alternatively, the camera may use its electronic array light sensor (103) or another light sensor to measure the scene lighting at the beginning of the composition time or preview mode. The scene lighting level may be compared with a threshold value. The camera may automatically enable the strobe flashes during composition when the available light is below the threshold value, indicating that there is insufficient light to allow the photographer to compose a photograph, and may disable the strobe flashes when the illumination level is above the threshold value.

The time during which the photographer is composing a photograph may begin when the photographer begins using the viewfinder or display to view the scene and evaluate camera positions for compositional quality. This may be coincident with a preview mode. The composition time or preview time typically ends when the photographer indicates, for example by fully depressing the shutter release, that he or she wishes the camera to initiate its final photograph taking sequence and take a final photograph.

During the composition or preview time, the camera may use strobe flashes of attenuated energy. That is, the flash or flashes may be less powerful than the strobe (106) is capable of, so that battery capacity is preserved and so that strobe energy is available on demand when the final photograph is taken. It may not be necessary that the preview photographs be of final-photograph quality. They need only be of sufficient quality for composition, which may be achievable with attenuated strobe energy.

For the purposes of this disclosure, a photograph may be any captured representation of a scene, including but not limited to a latent image on film, a photographic print, a transparency, or a digital representation stored in a memory or displayed on a screen.

Once a view is selected, the photographer may operate a shutter release that is a control input (112) of the camera to cause a final photograph to be taken.

The final photograph may be taken with the use of the strobe (106) or without, at the photographer's discretion. In addition to providing additional light (107) to assist with composition, the strobe flashes may be used by the camera for determining the proper strobe energy to use in taking the final photograph in order to achieve proper exposure. A method for determining the proper final photograph strobe energy based on preview photographs taken with and without a strobe is disclosed in U.S. patent application Ser. No. 09/886,448 of Hofer, “A camera with adjustable strobe energy.”

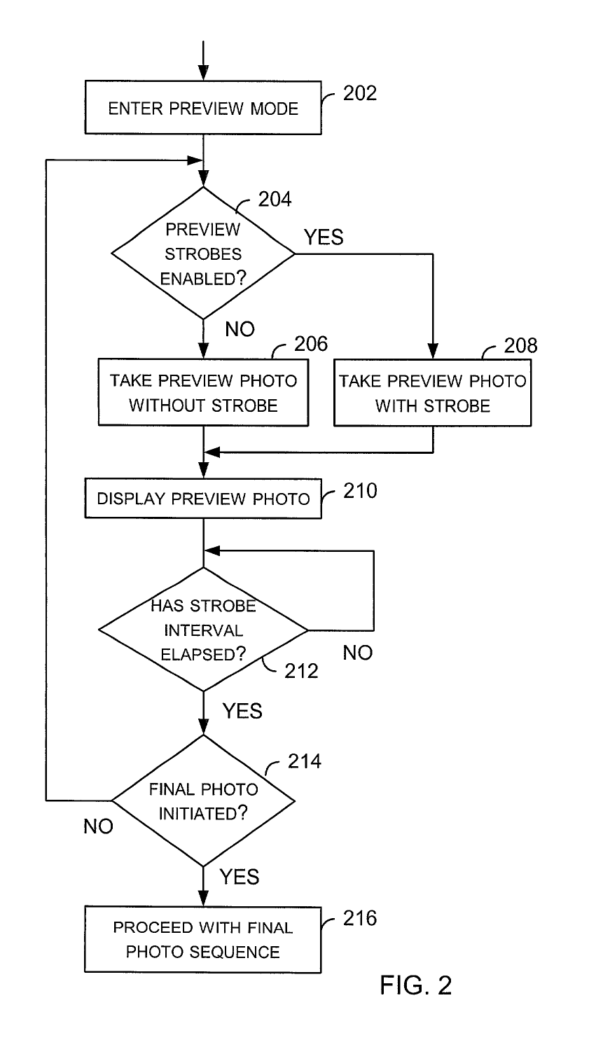

FIG. 2 depicts a flow chart showing steps a camera might take in an example embodiment of the invention in a digital camera with a display screen. Typically, the steps will be implemented in a computer program running on the microprocessor in the camera's logic unit (110).

In step 202, the preview mode is entered.

In step 204, the camera checks to see if the feature of using the strobe to assist the photographer in composition is enabled. If not, a preview photograph is taken without the strobe in step 206.

However, if the feature is enabled, the camera takes a preview photograph using the strobe in step 208. The camera may use a single strobe flash per preview photograph, or may flash the strobe more often than once per preview photograph. It is not necessary that each preview photograph encompass the same number of strobe flashes. The camera may vary the energy delivered to the strobe (106).

In step 210, the preview photograph is displayed on the camera's display screen (109).

At step 212, the camera repeatedly checks to see if the proper time interval has elapsed since the flash. A proper interval could be for example 250 milliseconds, but a camera designer of skill in the art may select a different interval based on the photographer's viewing comfort, the strobe energy capacity, the expected time that the camera will be in the preview mode, the energy expended in each preview strobe, the camera's strobe recharge capability, and other factors.

The camera may adjust the time interval or energy used per strobe flash or both as the preview mode progresses based on the remaining strobe energy, the camera's battery capacity, the expected strobe energy expected for a final photograph, or other factors.

Alternatively, the time interval could be nonexistent and the camera could proceed directly to step 214.

In step 214, the camera determines if the photographer has indicated, for example by fully depressing the shutter release button, that a final photograph is to be taken. If so, the preview mode ends and the camera proceeds with its final photograph taking sequence in step 216. If not, control passes back to step 204.

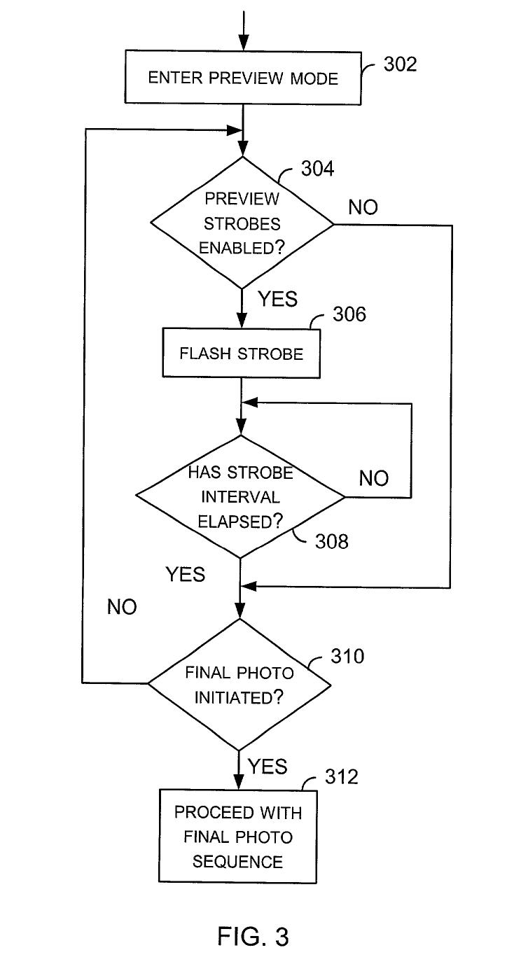

FIG. 3 depicts a flow chart showing steps a camera might take in an example embodiment of the invention in a film camera or a digital camera without a display screen. Typically, the steps will be implemented in a computer program running on the microprocessor in the camera's logic unit (110) while the photographer views the scene through the camera's viewfinder (114).

In step 302, the preview mode is entered.

In step 304, the camera checks to see if the feature of using the strobe to assist the photographer in composition is enabled. If not, control passes to step 310.

However, if the feature is enabled, the camera flashes the strobe in step 306. At step 308, the camera repeatedly checks to see if the proper time interval has elapsed since the flash. A proper interval could be for example 250 milliseconds, but a camera designer of skill in the art may select a different interval based on the photographer's viewing comfort, the strobe energy capacity, the expected time that the camera will be in the preview mode, the energy expended in each preview strobe, the camera's strobe recharge capability, and other factors.

The camera may adjust the time interval or energy used per strobe flash or both as the preview mode progresses based on the remaining strobe energy, the camera's battery capacity, the expected strobe energy expected for a final photograph, or other factors.

Alternatively, the time interval could be nonexistent and the camera could proceed directly to step 310.

In step 310, the camera determines if the photographer has indicated, for example by fully depressing the shutter release button, that a final photograph is to be taken. If so, the preview mode ends and the camera proceeds with its final photograph taking sequence in step 312. If not, control passes back to step 304.

Other sequences are possible within spirit of the invention. For example, FIGS. 2 and 3 describe a camera that polls its control inputs. Alternatively, the camera controls (112) could signal the camera logic unit (110) by an interrupt signal.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A camera comprising a strobe for supplying light to a scene, the strobe flashing repeatedly during composition of a photograph.

2. The camera of claim 1 further comprising a preview mode wherein the strobe flashes repeatedly.

3. The camera of claim 2 further comprising a user control by which the user selects the preview mode.

4. The camera of claim 3 wherein:
a) in response to a first setting of the user control, the strobe flashes repeatedly during the composition of a photograph; and
b) in response to a second setting of the user control, the strobe does not flash during the composition of a photograph.

5. The camera of claim 1 further comprising:
a) a light sensor, and
b) comparison means for comparing a light level measured with the light sensor to a threshold value, and wherein
the camera enables strobe flashes during composition of a photograph when the light level is below the threshold value, and disables the strobe flashes during composition of a photograph when the light level is above the threshold value.

6. The camera of claim 1 further comprising strobe electronics for driving the strobe, the strobe electronics having an energy storage capacity, each strobe flash during composition of a photograph dissipating less than all of the energy stored in the strobe electronics.

7. The camera of claim 6 wherein the amount of strobe energy dissipated for one strobe flash is different from the amount of strobe energy dissipated for another strobe flash.

8. The camera of claim 1 further comprising:
a) an electronic array light sensor; and
b) a logic unit that controls the electronic array light sensor and receives image data from the electronic array light sensor; and
c) a display that displays an image under control of the logic unit;
wherein the camera takes and displays preview photographs repeatedly on the display during composition of a final photograph by the user, and wherein the camera flashes the strobe once for each preview image.

9. The camera of claim 8 wherein the camera flashes the strobe more often than once for each preview image.

10. The camera of claim 9 wherein at least one of the preview images may use a different number strobe flashes than another preview image.

11. A method of controlling a camera comprising flashing a strobe repeatedly during composition of a photograph.

12. The method of claim 11 further comprising the steps of:
a) detecting a user control; and
b) entering a preview mode in response to the detecting step.

13. The method of claim 12 further comprising the steps of:
a) exiting the preview mode; and
b) suspending the repeated flashes of the strobe.

14. The method of claim 12 further comprising:
a) in response to a first setting of the user control, entering the preview mode and flashing the strobe repeatedly during composition of a photograph; and
b) in response to a second setting of the user control, entering the preview mode without flashing the strobe.

15. The method of claim 11 further comprising using a preview photograph taken during composition of a final photograph in determining the proper strobe energy to use in taking the final photograph.

16. The method of claim 11 further comprising dissipating less than all of an energy storage capacity of strobe electronics with each flash of the strobe during composition of a photograph.

17. The method of claim 16 wherein the amount of strobe energy dissipated for one strobe flash is different from the amount of strobe energy dissipated for another strobe flash.

18. The method of claim 11 further comprising the steps of:
a) measuring the scene lighting level using a light sensor; and
b) comparing the scene lighting level with a threshold value; and
c) enabling the strobe flashes during composition of a photograph when the scene lighting level is below the threshold value and disabling the strobe flashes during composition when the scene lighting level is above the threshold value.

19. A camera comprising:
a) strobe means for supplying light to a scene; and
b) electronics means for driving the strobe; and
c) logic means for controlling the strobe and electronics means, wherein the logic means flashes the strobe repeatedly during composition of a photograph by a user of the camera.
